(19) United States
(12) Patent Application Publication
(10) Pub. No.: US 2014/0327863 A1
(43) Pub. Date: Nov. 6, 2014

(54) LIQUID CRYSTAL DISPLAY DEVICE

(71) Applicant: FUJIFILM Corporation, Tokyo (JP)

(72) Inventors: Yujiro YANAI, Kanagawa (JP); Yukito SAITOH, Kanagawa (JP); Hiroshi SATO, Kanagawa (JP)

(73) Assignee: FUJIFILM CORPORATION, Tokyo (JP)

(21) Appl. No.: 14/263,585

(22) Filed: Apr. 28, 2014

(30) Foreign Application Priority Data
May 2, 2013 (JP) 2013-096970
Jun. 21, 2013 (JP) 2013-131048

(51) Int. Cl. G02F 1/13363

(52) U.S. Cl. CPC G02F 1/13363
USPC 349/102

(57) ABSTRACT

A VA-mode LCD device of four domains or less includes a first polarizing film; a first retardation layer; a second retardation layer; a liquid crystal layer; a third retardation layer; and a second polarizing film, wherein the first retardation layer has Re (550) of 190 to 260 nm, and Rth (550) of 80 to 130 nm, a slow axis of the first retardation layer and the absorption axis of the first polarizing film define an angle of 45°, the absolute value of a Re (550) of the second retardation layer is not larger than 10 nm, while a Rth (550) of the second retardation layer is 150 to 350 nm, a Re (550) of the third retardation layer is 190 to 260 nm, while a Rth (550) of the third retardation layer is −80 to −130 nm, and a Δnd of the liquid crystal layer is 250 to 450 nm.

The present application claims the benefit of priority from Japanese Patent Application No. 096970/2013, filed on May 2, 2013, and Japanese Patent Application No. 131048/2013, filed on Jun. 21, 2013, the content of which are herein incorporated by reference in their entirety.

### TECHNICAL FIELD

The present invention relates to a liquid crystal display device.

### BACKGROUND ART

In the recent flat-panel display market, higher definition pixels have been pursued to improve the image quality. The progress in compact displays such as tablet PCs and smartphones is particularly remarkable. In addition, high definition televisions called 4K2K are also appearing on the market.

Among known liquid crystal modes including a TN mode, an IPS mode, and a VA mode, the VA mode is dominant in televisions. Most of the current VA modes employ a pixel division scheme called eight domains (8D).

However, the eight-domain display has a complicated pixel structure, which is unsuitable for higher definition. Furthermore, the higher definition leads to a decrease in the use efficiency of the backlight. To achieve the compatibility between a simple structure and a sufficient use efficiency of the backlight, some displays employ a pixel division scheme involving a reduced number of domains (four domains (4D) or two domains (2D)).

However, a reduced number of domains leads to wash out of images (displayed images appear brighter when viewed from the side). The wash out is caused by a difference in the gradation characteristics (where the x axis is gray level and the y axis is transmittance in a graph) between a view from the front and that from the oblique position, which phenomenon is termed γ curve, for example. Some cells and films to prevent the wash out are disclosed (SID 06 Digest 69.3 pp. 1946-1949; and Optics Letters Vol. 38, No. 5 pp. 799-801).

### SUMMARY OF THE INVENTION

### Problems to be Solved by the Invention

SID 06 Digest 69.3 pp. 1946-1949 discloses a liquid crystal cell suppressing the wash out. However, when the wash out suppress by selecting a liquid crystal cell, there is a problem that liquid crystal cells are limited. Optics Letters Vol. 38, No. 5 pp. 799-801 suppress the wash out by using a particular retardation film. Unfortunately, such a retardation film readily causes tinting.

An object of the invention, which has been accomplished to solve the above-described problems, is to provide a VA-mode liquid crystal display device of four domains or less that causes less wash out and tinting.

### Means for Solving the Problems

Means for solving the problems described above are shown below in <1>, preferably <2> to <4>.

<1> A liquid crystal display device comprising: a first polarizing film; a first retardation layer; a second retardation layer; a liquid crystal layer; a third retardation layer; and a second polarizing film, in sequence, wherein

the liquid crystal layer has four domains or less, and is in a vertical alignment mode (VA mode) under no voltage application,

the first polarizing film has an absorption axis orthogonal to an absorption axis of the second polarizing film,

the first retardation layer has an in-plane retardation Re (550) of 190 to 260 nm at a wavelength of 550 nm, and has a thickness retardation Rth (550) of 80 to 130 nm at a wavelength of 550 nm,

a slow axis of the first retardation layer and the absorption axis of the first polarizing film define an angle of 45°,

the slow axis of the first retardation layer is parallel to an in-plane slow axis of the liquid crystal layer under voltage application,

the absolute value of a retardation Re (550) of the second retardation layer is not larger than 10 nm, while a retardation Rth (550) of the second retardation layer is 150 to 350 nm,

a retardation Re (550) of the third retardation layer is 190 to 260 nm, while a retardation Rth (550) of the third retardation layer is −80 to −130 nm,

a slow axis of the third retardation layer is orthogonal to the slow axis of the first retardation layer, and

a product Δnd of the refractive-index anisotropy Δn and the thickness d (μm) of the liquid crystal layer is 250 to 450 nm.

<2> The liquid crystal display device according to <1>, wherein

the absolute value of a difference in the retardation Re (550) between the first retardation layer and the third retardation layer is not larger than 10 nm, and

a difference in the absolute value of the retardation Rth (550) between the first retardation layer and the third retardation layer is not larger than 10 nm.

<3> The liquid crystal display device according to <1> or <2>, wherein at least one of the first retardation layer, the second retardation layer, and the third retardation layer comprises an optically anisotropic layer containing a liquid crystal compound.
<4> The liquid crystal display device according to any one of <1> to <3>, further comprising a fourth retardation layer between the first polarizing film and the first retardation layer or between the second polarizing film and the third retardation layer.

### Advantages of the Invention

The invention can achieve a VA-mode liquid crystal display device of four domains or less that causes less wash out and tinting.

### BRIEF DESCRIPTION OF THE DRAWINGS

FIG. 1 is a schematic diagram illustrating an example structure of a liquid crystal display device according to the invention;

FIG. 2 is a schematic diagram illustrating an example structure of a conventional liquid crystal display device;

FIG. 3 illustrates a shift of polarized light on the Poincare sphere in the structure in FIG. 2;

FIG. 4 illustrates a shift of polarized light on the Poincare sphere in the structure in FIG. 1; and

FIG. 5 is a schematic diagram illustrating another example structure of a liquid crystal display device according to the invention.

### BEST MODE FOR CARRYING OUT THE INVENTION

The present invention will be explained in detail below. As used herein, the numerical ranges expressed with “to” are used to mean the ranges including the values indicated before and after “to” as lower and upper limits.

Throughout the specification, the term “slow axis” indicates a direction providing a maximum refractive index.

Throughout the specification, the terms, such as “45°,” “parallel,” and “perpendicular” or “orthogonal,” each allow an error less than ±5° from the exact angle, unless otherwise stated. In other words, these terms indicate substantially 45°, substantially parallel, and substantially perpendicular, respectively. The error from the exact angle is preferably less than ±4°, and more preferably less than ±3°. Regarding angles, the sign “+” indicates the counterclockwise direction and the sign “−” indicates the clockwise direction.

The liquid crystal display device according to the invention includes a first polarizing film, a first retardation layer, a second retardation layer, a liquid crystal layer, a third retardation layer, and a second polarizing film, in sequence. The liquid crystal layer has four domains or less, and is in a vertical alignment mode (VA mode) under no voltage application. The absorption axis of the first polarizing film is orthogonal to that of the second polarizing film. The first retardation layer has an in-plane retardation Re (550) of 190 to 260 nm at a wavelength of 550 nm, and has a thickness retardation Rth (550) of 80 to 130 nm at a wavelength of 550 nm. The slow axis of the first retardation layer and the absorption axis of the first polarizing film define an angle of 45°. The slow axis of the first retardation layer is parallel to the in-plane slow axis of the liquid crystal layer under voltage application. The absolute value of the retardation Re (550) of the second retardation layer is 10 nm or less, while the retardation Rth (550) of the second retardation layer is 150 to 350 nm. The retardation Re (550) of the third retardation layer is 190 to 260 nm, while the retardation Rth (550) of the third retardation layer is −80 to −130 nm. The slow axis of the third retardation layer is orthogonal to that of the first retardation layer. The product Δnd of the refractive-index anisotropy Δn and the thickness d (μm) of the liquid crystal layer is 250 to 450 nm. These features allow the liquid crystal display device not to cause wash out or tinting. The term “tinting” indicates a phenomenon that tint appears when a film having a retardation Re of larger than λ/2 is interposed between two polarizing films.

Various techniques to prevent wash out have been examined. SID 06 Digest 69.3 pp. 1946-1949 discloses a technique of using different voltage application modes between pixels A (four domains) and pixels B (four domains) to display an average image. That is, the cell itself prevents wash out in the cited reference.

Optics Letters Vol. 38, No. 5 pp 0.799-801 discloses a retardation film preventing wash out. However, the present inventors have found that tinting occurs in the cited reference. This respect will now be described in detail with reference to the drawings.

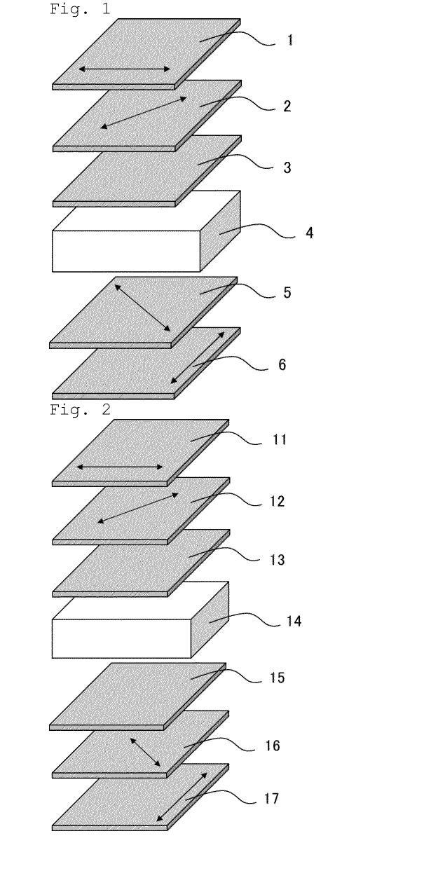

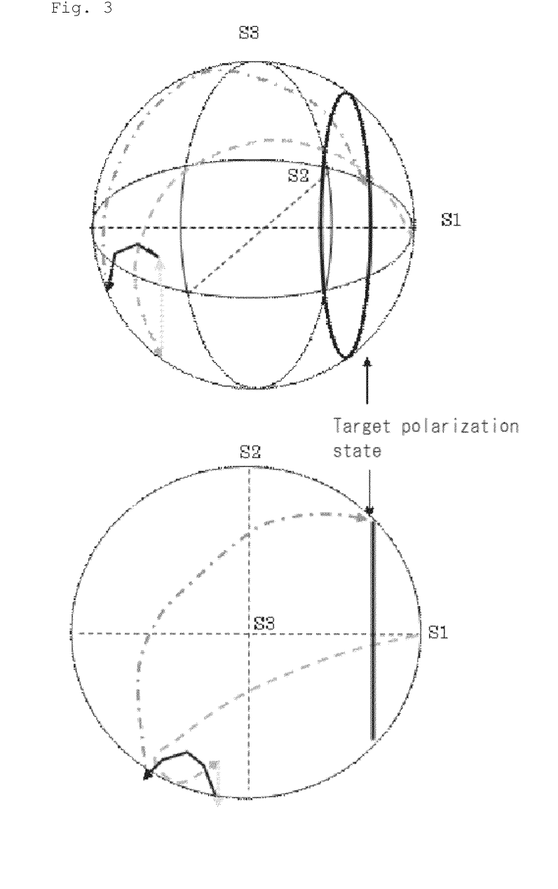

FIG. 1 is a schematic diagram illustrating an example structure of the liquid crystal display device according to the invention. A first polarizing film 1, a first retardation layer 2, a second retardation layer 3, a liquid crystal layer 4, a third retardation layer 5, and a second polarizing film 6 are laminated in order from the top. The liquid crystal display device disclosed in Optics Letters Vol. 38, No. 5 pp. 799-801 has a structure illustrated in FIG. 2. In contrast to FIG. 1, a first polarizing film 11, a first retardation layer 12, a fourth retardation layer 13, a liquid crystal layer 14, a second retardation layer 15, a third retardation layer 16, and a second polarizing film 17 are laminated in order from the top. The table below illustrates example retardations (unit: nm) at a wavelength of 550 nm for each of the retardation layers in FIGS. 1 and 2.

TABLE 1

| FIG. 1 | Re | Rth | FIG. 2 | Re | Rth |
|---|---|---|---|---|---|
| First polarizing | | | First polarizing | | |
| film | | | film | | |
| First retardation | 220 | 110 | First retardation | 320 | 160 |
| layer | | | layer | | |
| Second retardation | 0 | 300 | Fourth retardation | 275 | 0 |
| layer | | | layer | | |
| Liquid crystal | | | Liquid crystal | | |
| cell | | | cell | | |
| Third retardation | 220 | −110 | Second retardation | 0 | 300 |
| layer | | | layer | | |
| Second polarizing | | | Third retardation | 320 | −160 |
| film | | | layer | | |
| | | | Second polarizing | | |
| | | | film | | |

As shown in the table, the retardation Re of the first retardation layer 12 in FIG. 2 is 320 nm, which significantly exceeds λ/2 and, thereby, to cause tinting.

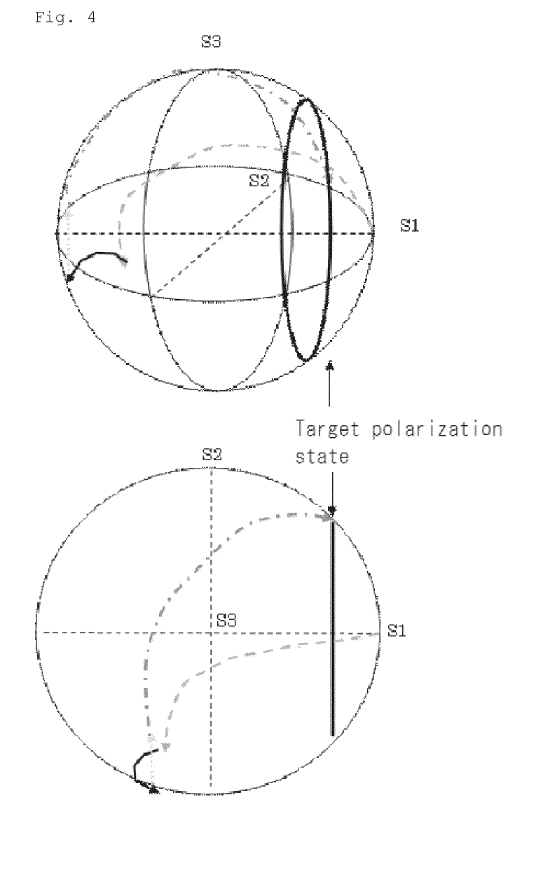

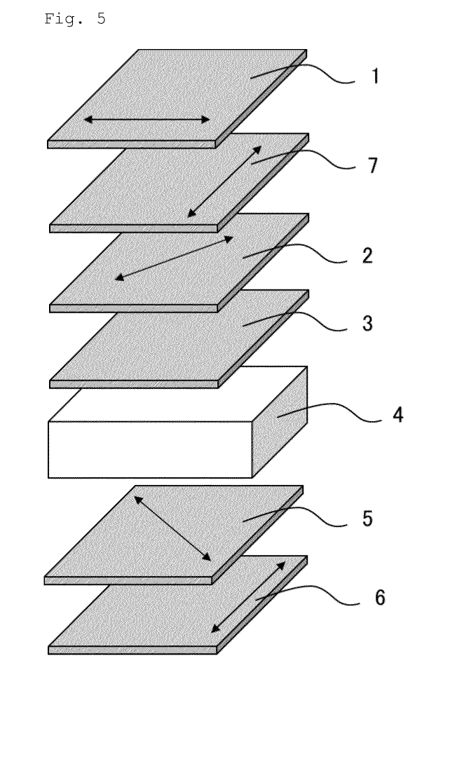

The difference between FIGS. 1 and 2 will now be described with reference to a shift of polarized light on the Poincare sphere illustrating each polarization state. FIGS. 3 and 4 each illustrate a shift of polarized light of a half tone at an azimuth of 0° and a polar angle of 60°.

For suppressing the wash out, the polarized light after passed through the second polarizing film (S1=1) needs to be positioned at a target polarization state after passing through each retardation layer.

In FIG. 3 (the layer configuration in FIG. 2), the retardation layer 15, which corresponds to the second retardation layer of the invention, is disposed between the second polarizing film 17 and the liquid crystal layer 14. The shift of the polarized light due to the construction also needs to be compensated. The retardations Re of the third retardation layer 16 and the first retardation layer 12 accordingly need to exceed λ/2.

In the layer configuration shown in FIG. 1, the second retardation layer 3 is disposed between the first retardation layer 2 and the liquid crystal layer 4. This configuration can achieve the target polarization state even if the retardations Re of the third retardation layer 5 and the first retardation layer 2 are smaller than those of the structure in FIG. 2.

The configuration of the invention will now be described in specific.

The liquid crystal display device according to the invention includes a first polarizing film, a first retardation layer, a second retardation layer, a liquid crystal layer, a third retardation layer, and a second polarizing film, in sequence. Either the top surface in FIG. 1 (the outer surface of the first polarizing film) or the bottom surface in FIG. 1 (the outer surface of the second polarizing film) may be closest to a viewer. Each of the first retardation layer, the second retardation layer, the third retardation layer, and the other retardation layers may have a single-layer or multi-layer configuration.

The absorption axis of the first polarizing film is orthogonal to that of the second polarizing film. The polarizing films may be any known polarizing film. For example, the relevant description in paragraph 0090 of Japanese Unexamined Patent Application Publication No. 2012-150377 is incorporated herein by reference.

The first retardation layer is disposed between the first polarizing film and the second retardation layer. The first retardation layer has an in-plane retardation Re (550) of 190 to 260 nm at a wavelength of 550 nm, and has a thickness retardation Rth (550) of 80 to 130 nm at a wavelength of 550 nm. The first retardation layer prevents wash out in cooperation with the third retardation layer.

The retardation Re (550) of the first retardation layer is preferably 200 to 250 nm, and more preferably 210 to 230 nm. The retardation Rth (550) of the first retardation layer is preferably 90 to 125 nm, and more preferably 100 to 120 nm. A typical example of such a film is a positive A-plate.

The first retardation layer may be fabricated by any known process so as to have the above-mentioned retardations. Examples of the process include the formation of an optically anisotropic layer containing a liquid crystal compound (in particular, such that rod-like liquid crystal molecules are horizontally aligned), the addition of a retardation adjustor, and/or stretching. For more details, the description of Japanese Patent No. 4825934 is incorporated herein by reference.

In terms of a reduction in thickness of the liquid crystal display device, the first retardation layer is preferably fabricated by forming an optically anisotropic layer containing a liquid crystal compound. The first retardation layer formed with the optically anisotropic layer containing a liquid crystal compound can achieve a thickness of approximately 1.0 to 3.0 μm.

In the liquid crystal layer having four domains, diagonally adjacent two domains each have an in-plane slow axis of 45° while the two other domains each have an in-plane slow axis of 135°, and the first retardation layer is a patterned retardation layer. In this case, the slow axis of a patterned retardation layer and that of another patterned retardation layer adjacent thereto define an angle of 90°. A technique to form a patterned retardation layer is disclosed in Japanese Unexamined Patent Application Publication No. 2013-011800, Japanese Unexamined Patent Application Publication No. 2013-068924, and Published Japanese Translation of PCT International Patent Publication No. 2012-517024, which are incorporated herein by reference.

The slow axis of the first retardation layer (e.g., the arrow in the first retardation layer 2 in FIG. 1) and the absorption axis of the first polarizing film (e.g., the arrow in the first polarizing film 1 in FIG. 1) define an angle of 45°. In addition, the slow axis of the first retardation layer is parallel to the in-plane slow axis of the liquid crystal layer under voltage application.

The first retardation layer may consist of an in-cell structure. Such an in-cell structure readily prevents wash out. If the first retardation layer consists of an in-cell structure, it is preferred that the second retardation layer and/or the third retardation layer also consist of an in-cell structure. A method of forming an in-cell structure is disclosed in Japanese Unexamined Patent Application Publication No. 2008-281989, which is incorporated herein by reference.

The second retardation layer is disposed between the first retardation layer and the liquid crystal layer. The absolute value of the retardation Re (550) of the second retardation layer is 10 nm or less, while the retardation Rth (550) of the second retardation layer is 150 to 350 nm. The second retardation layer functions as a compensator for the liquid crystal layer. It is therefore preferred that the second retardation layer and the liquid crystal layer retain no retardation layer therebetween. According to the invention, the second retardation layer is disposed near the first retardation layer. This configuration can reduce the retardation Re of the first retardation layer, to prevent tinting.

The retardation Rth (550) of the second retardation layer is preferably 200 to 350 nm, and more preferably 250 to 320 nm.

The absolute value of the retardation Re (550) of the second retardation layer is preferably 5 nm or less, and more preferably substantially 0 nm. A typical example of such a film is a negative C-plate.

The second retardation layer may be fabricated by any known process so as to have the above-mentioned retardations. Examples of the process include the formation of an optically anisotropic layer containing a liquid crystal compound (in particular, such that discotic liquid crystal molecules are horizontally aligned). For more details, the description of Japanese Unexamined Patent Application Publication No. 2008-40309 is incorporated herein by reference.

In terms of a reduction in thickness of the liquid crystal display device, the second retardation layer is preferably fabricated by forming an optically anisotropic layer containing a liquid crystal compound. The second retardation layer formed with the optically anisotropic layer containing a liquid crystal compound can achieve a thickness of approximately 2.0 to 4.0 μm.

The liquid crystal layer according to the invention has four domains or less, and is in a vertical alignment mode (VA mode) under no voltage application. The liquid crystal layer may have four domains or two domains, and four domains are preferred.

In the VA-mode liquid crystal cell, the transparent electrodes of the cell substrates have slits to determine the directions of slow axes in an applied electric field, as is disclosed in K. H. Kim, K. H. Lee, S. B. Park, J. K. Song, S. N. Kim, and J. H. Souk, Asia Display '98, p. 383, 1998. This configuration can determine the directions of tilt of liquid crystal molecules. For example, for two-domain cell having in-plane slow axes of 45° and 225° in an applied electric field, the slits in the transparent electrodes of the upper and lower substrates are formed to be directed to 135°, which is perpendicular to both 45° and 225°, such that slits of the upper substrate and the lower substrate are alternately aligned. The electric field is distorted at the edges of the slits in the transparent electrodes, so that the directions of tilt of liquid crystal molecules can be controlled. This configuration can provide desired in-plane slow axes in an applied electric field (this process is called patterned vertical alignment). In this case, the cell has two domains, because the in-plane slow axes of 45° and 225° coincide with each other while liquid crystal molecules tilt toward directions different between the domains of 45° and 225°. In the same way, for the two-domain cell having in-plane slow axes of 135° and 315° in an applied electric field, the slits in the transparent electrodes of the upper and lower substrates are directed to 45°, which is perpendicular to both 135° and 315°. For the four-domain cell having in-plane slow axes of 45°, 225°, 135°, and 315° in an applied electric field, the slits directed to 135° and the slits directed to 45° are provided in a mixed manner in the plane to the transparent electrodes of the upper and lower substrates.

The retardation of the VA-mode liquid crystal layer (i.e., the product Δnd of the refractive-index anisotropy Δn and the thickness d (μm) of the liquid crystal layer) is 250 to 450 nm, preferably 275 to 425 nm, and more preferably 300 to 400 nm. In the below-described examples of the invention, the retardation of the liquid crystal layer is referred to as Rth (Rth=−Δnd).

While no voltage is being applied to the liquid crystal cell (i.e., in a black display mode), the direction providing a maximum refractive index is substantially perpendicular to the substrate in the liquid crystal of the liquid crystal cell. The liquid crystal layer is therefore considered to be a positive C-plate.

For more details of the VA-mode liquid crystal cell and liquid crystal layer, the description of Japanese Unexamined Patent Application Publication No. 2013-076749 (in particular, paragraphs 0185 to 0187) is incorporated herein by reference.

The third retardation layer is disposed between the liquid crystal layer and the second polarizing film. The retardation Re (550) of the third retardation layer is 190 to 260 nm, while the retardation Rth (550) of the third retardation layer is −80 to −130 nm. The third retardation layer prevents wash out in cooperation with the first retardation layer. If the first retardation layer is a patterned retardation layer, the third retardation layer is also a patterned retardation layer.

The retardation Re (550) of the third retardation layer is preferably 200 to 250 nm, and more preferably 210 to 230 nm. The retardation Rth (550) of the third retardation layer is preferably −90 to −125 nm, and more preferably −100 to −120 nm. A typical example of such a film is a negative A-plate.

The first retardation layer and the third retardation layer prevent wash out in cooperation, as described above. It is accordingly preferred in the liquid crystal display device according to the invention that the absolute value of a difference in the retardation Re (550) between the first retardation layer and the third retardation layer be 10 nm or less, and that a difference in the absolute value of the retardation Rth (550) between the first retardation layer and the third retardation layer be 10 nm or less. A reduced difference in the retardation Re (550) between the first retardation layer and of the third retardation layer leads to more effective prevention of wash out. The difference in the absolute value of the retardation Rth (550) between the first retardation layer and the third retardation layer is preferably 5 nm or less, and more preferably substantially 0 nm. This configuration can more effectively enhance the front contrast.

The third retardation layer may be fabricated by any known process so as to have the above-mentioned retardations. Examples of the process include the formation of an optically anisotropic layer containing a liquid crystal compound (in particular, such that discotic liquid crystal molecules are vertically aligned), the addition of a retardation adjustor, and/or stretching. In terms of a reduction in thickness of the device, the third retardation layer is preferably fabricated by forming an optically anisotropic layer containing a liquid crystal compound. For more details, the description of Japanese Unexamined Patent Application Publication No. 2012-18396 is incorporated herein by reference.

In terms of a reduction in thickness of the liquid crystal display device, the third retardation layer is preferably fabricated by forming an optically anisotropic layer containing a liquid crystal compound. The third retardation layer formed with the optically anisotropic layer containing a liquid crystal compound can achieve a thickness of approximately 1.0 to 3.0 μm.

The third retardation layer may consist of an in-cell structure. Such an in-cell structure readily prevents wash out. If the third retardation layer consists of an in-cell structure, it is preferred that the first retardation layer and/or the second retardation layer also consist of an in-cell structure. A method of forming an in-cell structure is disclosed in Japanese Unexamined Patent Application Publication No. 2008-281989, which is incorporated herein by reference.

If the liquid crystal layer has four domains, the third retardation layer is a patterned retardation layer. A technique to form a patterned retardation layer is disclosed in Japanese Unexamined Patent Application Publication No. 2013-011800, Japanese Unexamined Patent Application Publication No. 2013-068924, and Published Japanese Translation of PCT International Patent Publication No. 2012-517024, which are incorporated herein by reference.

The liquid crystal layer having four domains may have a horizontal stripe pattern. Such horizontal stripe patterns are disclosed in Y. Tanaka, Y. Taniguchi, T. Sasaki, A. Takeda, Y. Koibe, and K. Okamoto, “A New Design to Improve Performance and Simplify the Manufacturing Process of High-Quality MVA TFT-LCD Panels”, SID Symposium Digest, p. 206, 1999; and K. H. Kim, K. H. Lee, S. B. Park, J. K. Song, S. N. Kim, and J. H. Souk, Asia Display '98, p. 383, 1998, which are incorporated herein by reference.

According to the invention, the slow axis of the third retardation layer (e.g., the arrow in the third retardation layer 5 in FIG. 1) is orthogonal to the slow axis of the first retardation layer (e.g., the arrow in the first retardation layer 2 in FIG. 1). In addition, the slow axis of the first retardation layer is parallel to the in-plane slow axis of the liquid crystal layer under voltage application.

The liquid crystal display device according to the invention can provide the same effects in both cases where a viewer is closest to the first polarizing film and where the viewer is closest to the second polarizing film, as long as the order of the layers is maintained.

The liquid crystal display device according to the invention may have another layer, within the gist of the invention. For example, a fourth retardation layer may be disposed between the first polarizing film and the first retardation layer, or between the second polarizing film and the third retardation layer.

FIG. 5 is a schematic diagram illustrating an example structure of the liquid crystal display device, which further includes a fourth retardation layer 7 between the first polarizing film and the first retardation layer. FIG. 5 uses reference signs common to FIG. 1. It is preferred that the slow axis of the fourth retardation layer (e.g., the arrow in the fourth retardation layer 7 in FIG. 5) be orthogonal to the absorption axis of the first polarizing film (e.g., the arrow in the first polarizing film 1 in FIG. 5). The fourth retardation layer 7 can compensate for the polarizing films, and further enhance the contrast in a view from a diagonal direction (viewing angle CR).

The fourth retardation layer may have a single-layer or multi-layer configuration.

In the single-layer configuration, the retardation Re (550) is preferably 250 to 305 nm, and more preferably 260 to 290 nm; while the retardation Rth (550) is preferably −30 to 30 nm, and more preferably −15 to 15 nm. The single-layer configuration, however, cannot easily control the wavelength dispersion, and readily causes black tint in a view from a diagonal direction.

A multi-layer configuration is more preferable to reduce black tint. The layer configuration of a biaxial film and a positive C-plate is most preferable among a variety of possible combinations. The retardation Re (550) of the biaxial film is preferably 70 to 140 nm, and more preferably 90 to 120 nm; while the retardation Rth (550) is preferably 40 to 110 nm, and more preferably 60 to 90 nm. The retardation Re (550) of the positive C-plate is preferably 10 nm or smaller; while the retardation Rth (550) is preferably −180 to −90 nm, and more preferably −160 to −110 nm.

A wide variety of known retardation films for compensation for polarizing films can be applied. For more details of the single-layer configuration, the description of Japanese Unexamined Patent Application Publication No. 2009-235374 is incorporated herein by reference. For more details of the multi-layer configuration, the description of Japanese Unexamined Patent Application Publication No. 2012-8548 is incorporated herein by reference.

In this description, Re (λ) and Rth (λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program.

When a film to be analyzed is expressed by a monoaxial or biaxial index ellipsoid, Rth(λ) of the film is calculated as follows. Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (21) and (22):

$$Re ( θ ) = [ nx - \frac{( ny \times nz )}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad ( 21 )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (21)

In the formula, nx represents a refractive index in the in-plane slow axis direction; ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

The instrument KOBRA-21ADH or KOBRA-WR calculates nx, ny, and nz, through input of the assumed average refractive index and the film thickness, and then calculates Nz=(nx−nz)/(nx−ny) on the basis of the calculated nx, ny, and nz.

Throughout the specification, the wavelength for measurement of the retardations Re and Rth is 550 nm, unless otherwise stated. The conditions for the measurement are a temperature of 25° C. and a relative humidity (RH) of 60%, unless otherwise stated.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### <Fabrication of Cellulose Acylate Film 001>

### <<Preparation of Cellulose Acylate>>

Cellulose acylate having a total degree of substitution of 2.97 (degree of acetyl substitution: 0.45, and degree of propionyl substitution: 2.52) was prepared. The mixture of sulfuric acid (7.8 parts by mass) as a catalyst and a dicarboxylic anhydride was cooled to −20° C., and then added to cellulose (100 parts by mass) derived from pulp. The cellulose was acylated at 40° C. The type and amount of the dicarboxylic anhydride was adjusted to control the type and degree of substitution of acyl groups. The total degree of substitution was further adjusted by aging at 40° C. after the acylation.

### <<Preparation of Cellulose Acylate Solution>>

### 1) Cellulose Acylate

The prepared cellulose acylate was heated to 120° C. and dried to decrease a moisture content to 0.5% by mass or lower. The cellulose acylate (30 parts by mass) was then mixed with solvents.

### 2) Solvents

Dichloromethane, methanol, and butanol (81, 15, and 4 parts by mass, respectively) were used as the solvents. The solvents each had a moisture content of 0.2% by mass or lower.

### 3) Additives

Trimethylolpropane triacetate (0.9 part by mass) and silicon-dioxide fine particles having a diameter of 20 nm (approximately 0.25 part by mass) were added to each solution preparation.

A UV absorbent A (1.2% by mass) and an Rth reducer B (11% by mass), which are represented by the formulae below, were added to 100 parts by mass of the cellulose acylate.

The resulting cellulose acylate film 001 had a retardation Re (550) of −1 nm and a retardation Rth (550) of −1 nm, and was optically isotropic.

### UV Absorbent A:

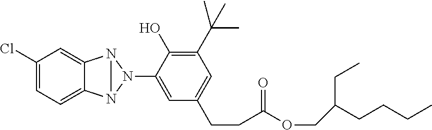 [SMILES: CCCCC(CC)COC(=O)CCc1cc(-n2n3c4ccc(Cl)cc4n23)c(O)c(C(C)(C)C)c1]

### Rth Reducer B:

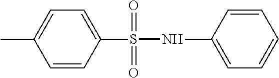 [SMILES: Cc1ccc(S(=O)(=O)Nc2ccccc2)cc1]

### 4) Swelling and Dissolution

The solvents and additives were introduced into a stainless solution tank provided with stirring blades while cooling water was being circulated therearound. The cellulose acylate was gradually added into the tank while its content was being stirred for dispersion. After completion of the addition, the content was stirred at a room temperature for two hours, allowed to swell for three hours, and then stirred again. This process produced a cellulose acylate solution.

The stirring was performed with a dissolver-type eccentric stirring rod for stirring at a rim speed of 15 m/sec (shear stress of 5×10⁴ kgf/m/sec²), and a stirring rod including an anchor blade at the central axis for stirring at a rim speed of 1 m/sec (shear stress of 1×10⁴ kgf/m/sec²). During the swelling process, the faster stirring rod was stopped while the stirring rod including the anchor blade was being operated at a rim speed of 0.5 m/sec.

### 5) Filtration

The resulting cellulose acylate solution was filtered through a filter paper #63 (manufactured by Toyo Roshi Kaisha, Ltd.) having an absolute filtration accuracy of 0.01 mm, and then filtered through a filter paper FH025 (manufactured by Pall Corporation) having an absolute filtration accuracy of 2.5 μm.

### <<Fabrication of Cellulose Acylate Film>>

The filtered cellulose acylate solution was warmed to 30° C., and was cast on a mirror-finished stainless support having a band length of 60 m and kept at 15° C. with a casting T-die (disclosed in Japanese Unexamined Patent Application Publication No. H11-314233). The casting rate was 15 m/min, and the coating width was 200 cm. The temperature of the space encompassing the entire casting portion was 15° C. The cellulose acylate film after casting and revolution was removed from the band at a position 50 cm before the casting portion, and exposed to a 45° C. dry air stream. After drying at 110° C. for five minutes and then 140° C. for ten minutes, a cellulose acylate film 001 having a thickness of 81 μm was prepared.

### <Process 1: Fabrication of Third Retardation Layer (Film Having Discotic Liquid Crystalline Compound Layer)>

A film for the third retardation layer included in the liquid crystal display device according to each of Examples 2, 4, 6, 8, and 10-16 and Comparative Examples 5, 7, 9, and 11, was fabricated by the following process.

### <<Alkali Saponification>>

The cellulose acylate film 001 was conveyed through a dielectric heating roller set at 60° C., to increase the film-surface temperature to 40° C. An alkaline solution having a composition shown below was applied to one surface of the film into a density of 14 ml/m² with a wire bar. The film was conveyed through a steamed far-infrared heater (manufactured by NORITAKE CO., LIMITED) kept at 110° C. for ten seconds. The film was then coated with pure water into a density of 3 ml/m² using the wire bar. After three cycles of a washing process using a fountain coater and a drainage process using an air knife, the film was conveyed for drying through a drying area at 70° C. for ten seconds. This process yielded an alkali-saponified cellulose acylate film.

### Composition of the Alkaline Solution

| | |
|---|---|
| Potassium hydroxide | 4.7 parts by mass |
| Water | 15.8 parts by mass |
| Isopropyl alcohol | 63.7 parts by mass |
| Surfactant SF-1: C₁₄H₂₉O(CH₂CH₂O)₂₀H | 1.0 part by mass |
| Propylene glycol | 14.8 parts by mass |

### <<Formation of Alignment Film>>

The long cellulose acetate film after saponification was continuously coated with an alignment-film coating solution having a composition shown below with a wire bar #14. The film was dried in a 60° C. warm air stream for 60 seconds, and then in a 100° C. warm air stream for 120 seconds.

### Composition of the Alignment-Film Coating Solution

| | |
|---|---|
| Modified poly(vinyl alcohol) (below) | 10 parts by mass |
| Water | 371 parts by mass |
| Methanol | 119 parts by mass |
| Glutaraldehyde | 0.5 part by mass |
| Photopolymerization initiator | 0.3 part by mass |
| (Irgacure-2959 manufactured by BASF) | |

### Modified Poly(Vinyl Alcohol)

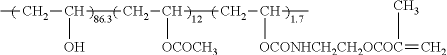

### <<Fabrication of Optically Anisotropic Layer Containing Discotic Liquid Crystalline Compound>>

The resulting alignment film was subjected to a continuous rubbing treatment. The long film was conveyed along its longitudinal direction. The rotation axis of a rubbing roller was directed to 45° clockwise to the conveyance direction of the film.

A coating solution (A) containing a discotic liquid crystalline compound (having a composition shown below) was applied on the resulting alignment film with a wire bar #2.7. The film was heated in an 80° C. warm air stream for 90 seconds for evaporating the solvents in the coating solution and for aging the alignment of the discotic liquid crystal molecules. The film was irradiated with ultraviolet rays at 80° C., to stabilize the alignment of the liquid crystal molecules and form an optically anisotropic layer. This process yielded a desired optical film. The thickness of the optically anisotropic layer was 2.0 μm.

### Composition of the Coating Solution (A) for an Optically Anisotropic Layer

| | | |
|---|---|---|
| Discotic liquid crystalline compound (below) | 100 | parts by mass |
| Photopolymerization initiator | 3 | parts by mass |
| (Irgacure-907 manufactured by BASF) | | |
| Sensitizer (Kayacure-DETX manufactured | 1 | part by mass |
| by Nippon Kayaku Co., Ltd.) | | |
| Pyridinium salt (below) | 1 | part by mass |
| Fluorine polymer FP1 (below) | 0.4 | part by mass |
| Methyl ethyl ketone | 252 | parts by mass |

### Discotic Liquid Crystalline Compound:

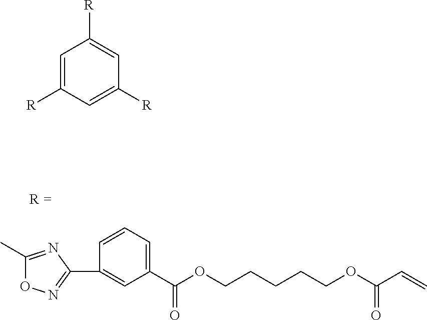

### Pyridinium Salt:

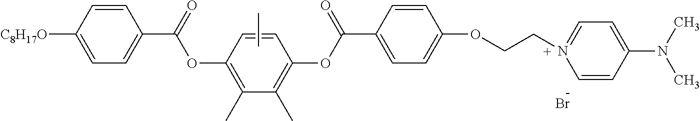

### Fluorine Polymer FP1:

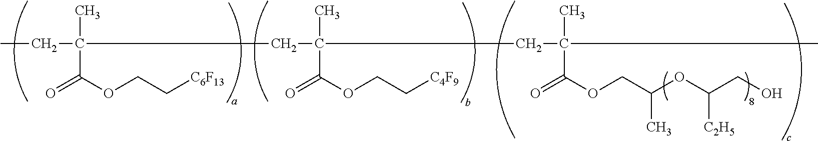

a/b/c=20/20/60 wt % Mw=16,000

The results of evaluation of the resulting optical films are shown below. The slow axis was parallel to the rotation axis of the rubbing roller. That is, the slow axis was directed to 45° clockwise to the longitudinal direction of the support. The thickness of the optically anisotropic layer was adjusted such that the film for each third retardation layer had retardations Re (550) and Rth (550) shown in the tables below.

### <Process 2: Fabrication of Second Retardation Layer (Film Having Discotic Liquid Crystalline Compound Layer)>

A film for the second retardation layer included in the examples and comparative examples of the present invention was fabricated by the following process.

The resulting cellulose acylate film 001 was subjected to an alkali saponification treatment, as in the fabrication of the third retardation layer.

### <<Formation of Alignment Film>>

An optically anisotropic layer having an adjusted thickness was laminated onto the cellulose acylate film 001, to fabricate a film for the second retardation layer, with reference to a technique disclosed in the examples of Japanese Unexamined Patent Application Publication No. 2008-40309.

### <<Fabrication of Optically Anisotropic Layer Containing Discotic Liquid Crystalline Compound>>

The resulting alignment film was subjected to a continuous rubbing treatment. The longitudinal direction of the long film is parallel to conveyance direction. The rotation axis of a rubbing roller was directed to 0° clockwise to the longitudinal direction of the film.

A coating solution (C) containing a discotic liquid crystalline compound (having a composition shown below) was continuously applied on the alignment film with a wire bar #2.7. The conveyance velocity (V) of the film was 36 m/min. The film was heated in a 100° C. warm air stream for 30 seconds and then in a 120° C. warm air stream for 90 seconds, for evaporating the solvents in the coating solution and for aging the alignment of the discotic liquid crystal molecules. The film was irradiated with ultraviolet rays at 80° C., to stabilize the alignment of the liquid crystal molecules and form an optically anisotropic layer. This process produced a desired optical film (negative C-plate). The retardations Re and Rth of the film were measured.

### Composition of the Coating Solution (C) for an Optically Anisotropic Layer

| | | |
|---|---|---|
| Discotic liquid crystalline compound (below) | 91 | parts by mass |
| Ethylene oxide modified trimethylolpropane | 9 | parts by mass |
| triacrylate (V#360 manufactured by Osaka | | |
| Organic Chemical Industry Ltd.) | | |
| Photopolymerization initiator | 3 | parts by mass |
| (Irgacure-907 manufactured by BASF) | | |
| Sensitizer (Kayacure-DETX manufactured | 1 | part by mass |
| by Nippon Kayaku Co., Ltd.) | | |
| Methyl ethyl ketone | 195 | parts by mass |

### Discotic Liquid Crystalline Compound

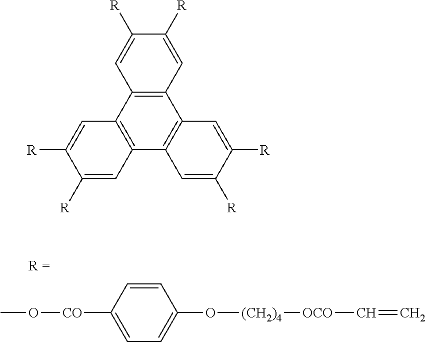

The thickness of the optically anisotropic layer was adjusted such that the film for each second retardation layer had a retardation Rth (550) shown in the tables below.

### <Process 3: Fabrication of First Retardation Layer (Film Having Rod-Like Liquid Crystal Compound Layer)>

A film for the first retardation layer included in the liquid crystal display device according to each of Examples 2, 4, 6, 8, and 10-16 and Comparative Examples 5, 7, 9, and 11, was fabricated by the following process.

An alkaline solution was applied to one surface of the resulting cellulose acylate film 001 for saponification. The film was then coated with an alignment-film coating solution (having a composition shown below) into a density of 20 ml/m² with a wire bar #14. After the film was dried in a 60° C. warm air stream for 60 seconds and then in a 100° C. warm air stream for 120 seconds, a precursor of an alignment film was prepared. The alignment film was completed by a rubbing treatment along the direction of 45° relative to the longitudinal direction of the cellulose acylate film 001.

### Composition of the Alignment-Film Coating Solution

| | |
|---|---|
| Modified poly(vinyl alcohol) (below) | 10 parts by mass |
| Water | 371 parts by mass |
| Methanol | 119 parts by mass |
| Glutaraldehyde | 0.5 part by mass |

### Modified Poly(Vinyl Alcohol):

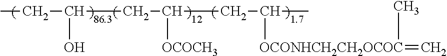

A coating solution for an optically anisotropic layer (having a composition shown below) was then applied with a wire bar #2.7.

| | | |
|---|---|---|
| Rod-like liquid crystal compound (below) | 1.8 | g |
| Ethylene oxide modified trimethylolpropane | 0.2 | g |
| triacrylate (V#360 manufactured by Osaka | | |
| Organic Chemical Industry Ltd.) | | |
| Photopolymerization initiator | 0.06 | g |
| (Irgacure-907 manufactured by BASF) | | |
| Sensitizer | 0.02 | g |
| (Kayacure-DETX manufactured by Nippon Kayaku Co., Ltd.) | | |
| Methyl ethyl ketone | 3.9 | g |

The resulting film was heated in a thermostatic chamber kept at 125° C. for three minutes, to align rod-like liquid crystal molecules. The film was then irradiated with ultraviolet rays for 30 seconds with a high-pressure mercury-vapor lamp having an output of 120 W/cm, to crosslink the rod-like liquid crystal molecules. The temperature during the ultraviolet curing was 80° C. An optically anisotropic layer having a thickness of 2.0 μm was thereby prepared. The film was allowed to stand to cool to room temperature. This process produced a desired optical film (positive A-plate). Rod-like liquid crystal compound:

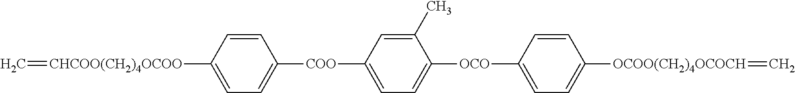

The thickness of the optically anisotropic layer was adjusted such that the film for each first retardation layer had retardations Re (550) and Rth (550) shown in the tables below.

### <Process 4: Fabrication of Third Retardation Layer (Patterned Retarder)>

A film for the third retardation layer included in the liquid crystal display device according to each of Examples 1, 3, 5, 7, and 9 and Comparative Examples 4, 6, 8, and 10, was fabricated by the following process.

### <<Alkali Saponification>>

The cellulose acylate film 001 was conveyed through a dielectric heating roller set at 60° C., to increase the surface temperature of the film to 40° C. An alkaline solution having a composition shown below was applied to one surface of the film into a density of 14 ml/m² with a wire bar. The film was conveyed through a steamed far-infrared heater (manufactured by NORITAKE CO., LIMITED) kept at 110° C. for ten seconds. The film was then coated with pure water into a density of 3 ml/m² with the wire bar. After three cycles of a washing process using a fountain coater and a drainage process using an air knife, the film was conveyed for drying through a drying area at 70° C. for ten seconds. This process yielded an alkali-saponified cellulose-acetate transparent support.

Composition of the Alkaline Solution

| | |
|---|---|
| Potassium hydroxide | 4.7 parts by mass |
| Water | 15.8 parts by mass |
| Isopropyl alcohol | 63.7 parts by mass |
| Surfactant SF-1: C₁₄H₂₉O(CH₂CH₂O)₂₀H | 1.0 part by mass |
| Propylene glycol | 14.8 parts by mass |

### <<Formation of Rubbed Alignment Film>>

The saponified surface of the resulting support was continuously coated with a coating solution for a rubbed alignment-film (having a composition shown below) with a wire bar #8. After the coating layer was dried in a 60° C. warm air stream for 60 seconds and then in a 100° C. warm air stream for 120 seconds, a rubbed alignment film was prepared. A striped mask (the width of each horizontal stripe was 100 μm in light-transmissive portions, and 300 μm in light-shielding portions) was disposed on the rubbed alignment film. The film was irradiated with ultraviolet rays in air at room temperature for four seconds, with an air-cooled metal halide lamp (manufactured by EYE GRAPHICS CO., LTD.) having a luminance of 2.5 mW/cm² in the UV-C band, so that a photo-acid generator was decomposed to acid. This process yielded regions in the alignment film for the first retardation areas. After a single reciprocation of a rubbing treatment at 500 rpm along one direction, the transparent support provided with the rubbed alignment film was prepared. The thickness of the alignment film was 0.5 μm.

### Composition of the Coating Solution for an Alignment Film Polymer Material for an Alignment Film (Poly(Vinyl Alcohol) PVA103 Manufactured by KURARAY CO., LTD.)

| | |
|---|---|
| Photo-acid generator S-2 | 3.9 parts by mass |
| Methanol | 0.1 part by mass |
| Water | 36 parts by mass |
| Photo-acid generator S-2: | 60 parts by mass |

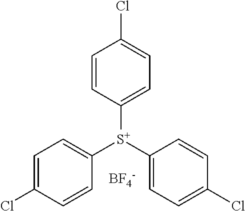

### <<Formation of Patterned Optically Anisotropic Layer>>

A composition for an optically anisotropic layer (having a composition shown below) was prepared, and filtered through a polypropylene filter having a pore diameter of 0.2 μm, to yield a coating solution for an optically anisotropic layer. The solution was applied to the support into a density of 8 ml/m² with a wire bar. The support was dried at a film-surface temperature of 110° C. for two minutes, to form a liquid crystalline phase and to achieve a uniform alignment. The support was then cooled to 100° C., and was irradiated with ultraviolet rays in air for 20 seconds, with an air-cooled metal halide lamp (manufactured by EYE GRAPHICS CO., LTD.) having a luminance of 20 mW/cm², to stabilize the alignment state. This process produced a patterned optically anisotropic layer. The discotic liquid crystal (DLC) molecules were vertically aligned, such that the slow-axis direction was parallel to the rubbing direction in areas exposed from the mask (first retardation areas) while the directions were orthogonal to each other in unexposed areas (second retardation areas). The thickness of the optically anisotropic layer was 1.6 μm.

### Composition for an Optically Anisotropic Layer

| | |
|---|---|
| Discotic liquid crystal E-1 | 100 parts by mass |
| Alignment agent for alignment-film interface (II-1) | 3.0 parts by mass |
| Alignment agent for air interface (P-1) | 0.4 part by mass |
| Photopolymerization initiator | 3.0 parts by mass |
| (Irgacure-907 manufactured by BASF) | |
| Sensitizer | 1.0 part by mass |
| (Kayacure-DETX manufactured | |
| by Nippon Kayaku Co., Ltd.) | |
| Methyl ethyl ketone | 400 parts by mass |

### Discotic Liquid Crystal E-1:

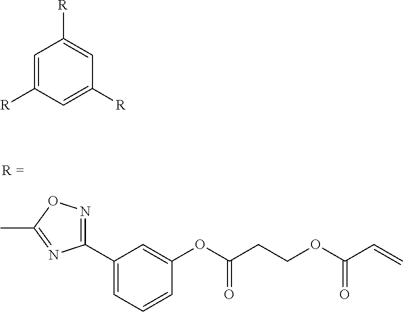

### Alignment Agent for Alignment-Film Interface (II-1):

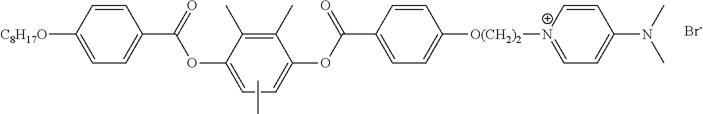

### Alignment Agent for Air Interface (P-1):

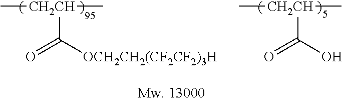

The first and second retardation areas of the resulting patterned optical film were analyzed by a time-of-flight secondary ion mass spectrometry (TOF-SIMS V provided by ION-TOF). The molar ratio in the first retardation area to the second retardation area of the photo-acid generator S-2 in the alignment film was 8 to 92. The results indicate that most of the photo-acid generator S-2 was decomposed in the first retardation area. Cations from the agent II-1 and anions BF₄⁻ from the acid HBF₄ generated by the photo-acid generator S-2 are observed at the air interface of the first retardation area in the optically anisotropic layer. In contrast, in the second retardation area, these ions were scarcely observed at the air interface, while cations from the agent II-1 and anions Br⁻ are observed near the alignment-film interface. The ratio of the cations from the agent II-1 was 93 to 7, and that of the anions BF₄⁻ was 90 to 10, at the air interfaces of the retardation areas. That is, the alignment agent for alignment-film interface II-1 was concentrated near the alignment-film interface in the second retardation area, while the agent II-1 was more evenly distributed and diffused to the air interface in the first retardation area. In addition, anion exchange between the generated acid HBF₄ and the agent II-1 promoted the diffusion of the cations from the agent II-1 across the first retardation area.

The thickness of the optically anisotropic layer was adjusted such that the film for each third retardation layer had retardations Re (550) and Rth (550) shown in the tables below.

### <Process 5: Fabrication of First Retardation Layer (Patterned Retarder)>

A film for the first retardation layer included in the liquid crystal display device according to each of Examples 1, 3, 5, 7, and 9 and Comparative Examples 4, 6, 8, and 10, was fabricated by the following process.

An alignment film was formed as in the fabrication of the third retardation layer (patterned retarder). One surface of the alignment film was coated with an optically anisotropic layer such that LC242 (rod-like liquid crystal (RLC) manufactured by BASF) contained therein defines the first and second retardation areas, by a technique disclosed in the examples of Published Japanese Translation of PCT International Patent Publication No. 2012-517024.

The thickness of the optically anisotropic layer was adjusted such that the film for each first retardation layer had retardations Re (550) and Rth (550) shown in the tables below.

### <Fabrication of Fourth Retardation Layer (Optical Compensation Film)>

The fourth retardation layers shown in the tables were fabricated by a technique disclosed in the examples of Japanese Unexamined Patent Application Publication No. 2012-8548.

### <Fabrication of Liquid Crystal Display Device>

### <<Polarizing Film>>

As is disclosed in Example 1 of Japanese Unexamined Patent Application Publication No. 2001-141926, a stretched poly(vinyl alcohol) film was allowed to adsorb iodine, to form a polarizer having a thickness of 20 μm.

Anyone of the first, third, and fourth retardation layers was saponified and laminated onto one surface of the polarizer with a poly(vinyl alcohol) adhesive, to have a layer configuration shown in each table below. The resultant was dried at 70° C. for ten minutes or longer. A commercially-available cellulose acetate film (TD80 manufactured by FUJIFILM Corporation) was saponified and laminated onto the other surface of the polarizer in the same way. This process yielded a polarizing film.

### <<Fabrication of VA-Mode Liquid Crystal Cell>>

The cell gap between the substrates was set at 3.6 μm, was filled with a liquid crystal material having negative dielectric-constant anisotropy (MLC 6608 manufactured by Merck KGaA), and was sealed, to form a liquid crystal layer between the substrates. The thickness d of the liquid crystal layer was adjusted such that the liquid crystal layer had a retardation (i.e., product Δnd of the refractive-index anisotropy Δn and the thickness d (μm) of the liquid crystal layer) shown in each table below. The liquid crystal molecules were vertically aligned. This process produced a VA-mode liquid crystal cell.

### <<Bonding of Liquid Crystal Cell to Polarizing Film>>

The films were bonded to each other to form a VA-mode liquid crystal display device, such that the device had a layer configuration shown in Table 1, and the slow axes and the absorption axes had a relationship shown in each table below. The details of Example 16 were as follows:

### <Fabrication According to Example 16>

### <<Polarizing Film>>

As is disclosed in Example 1 of Japanese Unexamined Patent Application Publication No. 2001-141926, a stretched poly(vinyl alcohol) film was allowed to adsorb iodine, to form a polarizer having a thickness of 20 μm.

### <<Fabrication of Optically Anisotropic Layer>>

A commercially-available cellulose acetate film (TD80 manufactured by FUJIFILM Corporation) was saponified and laminated onto one surface of the polarizer with a poly(vinyl alcohol) adhesive. The resultant was dried at 70° C. for ten minutes or longer.

Except for a rubbing treatment on the surface opposite to the laminated surface, the process was identical to that of Example 14. That is, the first retardation layer was directly laminated onto the first polarizing film, and the third retardation layer was directly laminated onto the second polarizing film.

TABLE 2

| | Example1 | | | Example2 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 & 135 | 220 | 110 | 45 |
| Second retardation layer | 0 | 250 | — | 0 | 250 | — |
| Liquid crystal cell | 0 | −300 | 4D | 0 | −300 | 2D |
| Third retardation layer | 220 | −110 | 135 & 45 | 220 | −110 | 135 |
| Second polarizing film | — | — | 90 | — | — | 90 |

TABLE 3

| | Example3 | | | Example4 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 250 | 125 | 45 & 135 | 250 | 125 | 45 |
| Second retardation layer | 0 | 250 | — | 0 | 250 | — |
| Liquid crystal cell | 0 | −300 | 4D | 0 | −300 | 2D |
| Third retardation layer | 250 | −125 | 135 & 45 | 250 | −125 | 135 |
| Second polarizing film | — | — | 90 | — | — | 90 |

TABLE 4

| | Example5 | | | Example6 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 200 | 100 | 45 & 135 | 200 | 100 | 45 |
| Second retardation layer | 0 | 250 | — | 0 | 250 | — |
| Liquid crystal cell | 0 | −300 | 4D | 0 | −300 | 2D |
| Third retardation layer | 200 | −100 | 135 & 45 | 200 | −100 | 135 |
| Second polarizing film | — | — | 90 | — | — | 90 |

TABLE 5

| | Example7 | | | Example8 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 & 135 | 220 | 110 | 45 |
| Second retardation layer | 0 | 175 | — | 0 | 175 | — |
| Liquid crystal cell | 0 | −300 | 4D | 0 | −300 | 2D |
| Third retardation layer | 220 | −110 | 135 & 45 | 220 | −110 | 135 |
| Second polarizing film | — | — | 90 | — | — | 90 |

TABLE 6

| | Example9 | | | Example10 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 & 135 | 220 | 110 | 45 |
| Second retardation layer | 0 | 325 | — | 0 | 325 | — |
| Liquid crystal cell | 0 | −300 | 4D | 0 | −300 | 2D |
| Third retardation layer | 220 | −110 | 135 & 45 | 220 | −110 | 135 |
| Second polarizing film | — | — | 90 | — | — | 90 |

TABLE 7

| | Example11 | | | Example12 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 | 220 | 110 | 45 |
| Second retardation layer | 0 | 200 | — | 0 | 350 | — |
| Liquid crystal cell | 0 | −250 | 2D | 0 | −450 | 2D |
| Third retardation layer | 220 | −110 | 135 | 220 | −110 | 135 |
| Second polarizing film | — | — | 90 | — | — | 90 |

TABLE 8

| | Comparative example1 | | | Comparative example2 | | | Comparative example3 | | |
|---|---|---|---|---|---|---|---|---|---|
| | Optical characteristic | | | Optical characteristic | | | Optical characteristic | | |
| Layer | | | Slow axis or | | | Slow axis or | | | Slow axis or |
| configuration | Re [nm] | Rth [nm] | Absorption axis | Re [nm] | Rth [nm] | Absorption axis | Re [nm] | Rth [nm] | Absorption axis |
| First polarizing film | — | — | 0 | — | — | 0 | — | — | 0 |
| Fourth retardation layer | 100 | 100 | 90 | 100 | 100 | 90 | 100 | 100 | 90 |
| | 0 | −160 | — | 0 | −160 | — | 0 | −160 | — |
| First retardation layer | — | — | — | — | — | — | — | — | — |
| Second retardation layer | 0 | 300 | — | 0 | 300 | — | 0 | 300 | — |
| Liquid crystal cell | 0 | −300 | 8D | 0 | −300 | 4D | 0 | −300 | 2D |
| Third retardation layer | — | — | — | — | — | — | — | — | — |
| Second polarizing film | — | — | 90 | — | — | 90 | — | — | 90 |

TABLE 9

| | Comparative example4 | | | Comparative example5 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 320 | 160 | 45 & 135 | 320 | 160 | 45 |
| Second retardation layer | 0 | 250 | — | 0 | 250 | — |
| Liquid crystal cell | 0 | −300 | 4D | 0 | −300 | 2D |
| Third retardation layer | 320 | −160 | 135 & 45 | 320 | −160 | 135 |
| Second polarizing film | — | — | 90 | — | — | 90 |

TABLE 10

| | Comparative example6 | | | Comparative example7 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 150 | 75 | 45 & 135 | 150 | 75 | 45 |
| Second retardation layer | 0 | 250 | — | 0 | 250 | — |
| Liquid crystal cell | 0 | −300 | 4D | 0 | −300 | 2D |
| Third retardation layer | 150 | −75 | 135 & 45 | 150 | −75 | 135 |
| Second polarizing film | — | — | 90 | — | — | 90 |

TABLE 11

| | Comparative example8 | | | Comparative example9 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 & 135 | 220 | 110 | 45 |
| Second retardation layer | 0 | 370 | — | 0 | 370 | — |
| Liquid crystal cell | 0 | −300 | 4D | 0 | −300 | 2D |
| Third retardation layer | 220 | −110 | 135 & 45 | 220 | −110 | 135 |
| Second polarizing film | — | — | 90 | — | — | 90 |

TABLE 12

| | Comparative example10 | | | Comparative example11 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 & 135 | 220 | 110 | 45 |
| Second retardation layer | 0 | 130 | — | 0 | 130 | — |
| Liquid crystal cell | 0 | −300 | 4D | 0 | −300 | 2D |
| Third retardation layer | 220 | −110 | 135 & 45 | 220 | −110 | 135 |
| Second polarizing film | — | — | 90 | — | — | 90 |

TABLE 13

| | Comparative example12 | | | Comparative example13 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | 100 | 100 | 90 |
| | 0 | −160 | — | 0 | −160 | — |
| First retardation layer | 220 | 110 | 45 | 220 | 110 | 45 |
| Second retardation layer | 0 | 200 | — | 0 | 350 | — |
| Liquid crystal cell | 0 | −200 | 2D | 0 | −500 | 2D |
| Third retardation layer | 220 | −110 | 135 | 220 | −110 | 135 |
| Second polarizing film | — | — | 90 | — | — | 90 |

TABLE 14

| | Example13 | | | Example 14 | | |
|---|---|---|---|---|---|---|
| | Optical characteristic | | | Optical characteristic | | |
| Layer | | | Slow axis or | | | Slow axis or |
| configuration | Re [nm] | Rth [nm] | Absorption axis | Re [nm] | Rth [nm] | Absorption axis |
| First polarizing film | — | — | 0 | — | — | 0 |
| Fourth retardation layer | 100 | 100 | 90 | — | — | — |
| | 0 | −160 | — | — | — | — |
| First retardation layer | 200 | 100 | 45 | 220 | 110 | 45 |
| Second retardation layer | 0 | 250 | — | 0 | 250 | — |
| Liquid crystal cell | 0 | −300 | 2D | 0 | −300 | 2D |
| Third retardation layer | 220 | −100 | 135 | 200 | −110 | 135 |
| Second polarizing film | — | — | 90 | — | — | 90 |

TABLE 15

| | Example 15 | | |
|---|---|---|---|
| | Optical characteristic | | |
| Layer | | | Slow axis |
| configuration | Re[nm] | Rth[nm] | or Absorption axis |
| First polarizing film | — | — | 0 |
| First retardation layer | 220 | 110 | 45 |
| | 0 | 250 | — |
| Second retardation layer | 0 | −300 | 2D |
| Liquid crystal cell | 220 | −110 | 135 |
| Third retardation layer | 0 | −160 | — |
| Fourth retardation layer | 100 | 100 | 0 |
| Second polarizing film | — | — | 90 |

According to Example 15, the fourth retardation layer was formed to adjoin the second polarizing film by Process 3.

TABLE 16

| | Example 16 | | |
|---|---|---|---|
| | Optical characteristic | | |
| Layer | | | Slow axis |
| configuration | Re[nm] | Rth[nm] | or Absorption axis |
| First polarizing film | — | — | 0 |
| Fourth retardation layer | — | — | — |
| | — | — | — |
| First retardation layer | 220 | 110 | 45 |
| Second retardation layer | 0 | 250 | — |
| Liquid crystal cell | 0 | −300 | 2D |
| Third retardation layer | 220 | −110 | 135 |
| Second polarizing film | — | — | 90 |

According to Example 16, the first retardation layer was directly laminated onto a polarizing film, and the third retardation layer was directly laminated onto another polarizing film by Process 1.

TABLE 17

| | Example 17 | | |
|---|---|---|---|
| | Optical characteristic | | |
| Layer | | | Slow axis |
| configuration | Re[nm] | Rth[nm] | or Absorption axis |
| First polarizing film | — | — | 0 |
| Fourth retardation layer | 100 | 100 | 90 |
| | 0 | −160 | — |
| First retardation layer | 220 | 110 | 45 & 135 |
| Second retardation layer | 0 | 250 | — |
| Liquid crystal cell | 0 | −300 | 4D |
| Third retardation layer | 220 | −110 | 135 & 45 |
| Second polarizing film | — | — | 90 |

According to Example 17, the first and second retardation layers were formed onto a color filter of each pixel and the third retardation layer was formed onto a TFT, with reference to Japanese Unexamined Patent Application Publication No. 2008-281989. The process other than this step was identical to those of Examples 1 and 2.

In the above tables, the term “2D” indicates a pixel of the liquid crystal cell having two domains, “4D” indicates a pixel of four domains, and “8D” indicates a pixel of eight domains.

The angle of each of the slow axes and the absorption axes is defined relative to the absorption axis (0°) of the first polarizing film (the counterclockwise direction as viewed from a viewer is positive).

### <Evaluation>

The resulting liquid crystal display device was evaluated as below, with a tester “EZ-Contrast XL88” (manufactured by ELDIM).

### <<Wash Out>>

The γ curve in a view from the front was determined to be 2.2, such that 100×(each signal value/maximum signal value)^{2.2} equals to a normalized brightness (relative to white brightness of 100) of each signal value. The brightness at a signal value of 128 and the brightness of a white display were measured. The ratio (the brightness at the signal value of 128 to the white brightness) was then calculated for each of a view from the front and views from four directions (right, bottom, left, and top (azimuth: 0°, 90°, 180°, and 270°)) at a polar angle of 60°. The difference between the ratio for the front and an average ratio for the four directions was calculated, and evaluated based on the following criteria.

A: 0≦difference<0.05
B: 0.05≦difference<0.10
C: 0.10≦difference<0.15
D: 0.15≦difference

### <<Tinting>>

The difference Δu′v′ in tint of the white brightness between a view from the front and a view from the right (azimuth: 0°) at a polar angle of 60° was calculated using the following expression:

Δu′v′=√(u′_right−u′_front)̂2+(v′_right−v′_front)̂2

The calculated difference Δu′v′ was evaluated based on the following criteria.
A: 0≦Δu′v′<0.005
B: 0.005≦Δu′v′<0.01
C: 0.01≦Δu′v′

### <<Viewing Angle Contrast>>

The brightness of a white display and that of a black display were measured. The average value of the contrast ratios (the white brightness/the black brightness) for views from four diagonal directions (azimuth: 45°, 135°, 225°, and 315°) at a polar angle 60° was calculated, and evaluated based on the following criteria.

A: 10≦average
B: 5≦average<10
C: average<5

### <<Use Efficiency of Backlight (BL)>>

The brightness of a white display and that of the backlight alone were measured, and the ratio thereof (the white brightness/the backlight brightness) was calculated. The proportion of the ratio to that in Comparative Example 1 (the ratio in each Example or Comparative Example to the ratio in Comparative Example 1) was calculated, and evaluated based on the following criteria.

A: 105≦proportion
B: 102.5≦proportion<105
C: 100≦proportion<102.5

### <<Front Contrast (CR)>>

The brightness of a white display and that of a black display were measured, and the contrast ratio (the white brightness/the black brightness) in a view from the front was calculated. The proportion of the front contrast to that in Comparative Example 1 (the front contrast in each Example or Comparative Example to the front contrast in Comparative Example 1) was calculated, and evaluated based on the following criteria.

A: 98≦proportion
B: 90≦proportion<98
C: proportion<90

The results of the evaluations are shown in the table below.

TABLE 18

| | Evaluation | | | | |
|---|---|---|---|---|---|
| | | | Viewing | Use | |
| | | | Angle | Efficiency | Front |
| | Wash out | Tinting | Contrast | of Backlight | Contrast |
| Example 1 | A | A | A | B | A |
| Example 2 | A | A | A | A | A |
| Example 3 | B | B | A | B | A |
| Example 4 | B | B | A | A | A |
| Example 5 | B | A | A | B | A |
| Example 6 | B | A | A | A | A |
| Example 7 | A | A | B | B | A |
| Example 8 | A | A | B | A | A |
| Example 9 | A | A | B | B | A |
| Example 10 | B | A | A | A | A |
| Example 11 | A | A | A | B | A |
| Example 12 | A | A | A | B | A |
| Comparative | C | A | A | C | A |
| example 1 | | | | | |
| Comparative | D | A | A | B | A |
| example 2 | | | | | |
| Comparative | D | A | A | A | A |
| example 3 | | | | | |
| Comparative | A | C | A | B | A |
| example 4 | | | | | |
| Comparative | A | C | A | A | A |
| example 5 | | | | | |
| Comparative | D | A | A | B | A |
| example 6 | | | | | |
| Comparative | D | A | A | A | A |
| example 7 | | | | | |
| Comparative | C | A | C | B | A |
| example 8 | | | | | |
| Comparative | C | A | C | A | A |
| example 9 | | | | | |
| Comparative | C | A | C | B | A |
| example 10 | | | | | |
| Comparative | C | A | C | A | A |
| example 11 | | | | | |
| Comparative | B | A | C | C | A |
| example 12 | | | | | |
| Comparative | C | A | C | C | A |
| example 13 | | | | | |
| Example 13 | A | A | A | A | C |
| Example 14 | A | A | C | A | A |
| Example 15 | A | A | A | A | A |
| Example 16 | A | A | C | A | A |
| Example 17 | A | A | A | A | A |

The table demonstrates that the liquid crystal display devices according to the invention cause less wash out and exhibit improved usage efficiency of the backlights. In contrast, Comparative Examples 1 to 3, which lack the third retardation layer, cause wash out. In addition, Comparative Example 1, involving a liquid crystal cell having eight-domain pixels, exhibits decreased usage efficiency of the backlight. Comparative Examples 4 to 7, in which the retardations Re and Rth of the first and third retardation layers were not within the ranges according to the invention, cause wash out. Comparative Examples 8 to 11, in which the retardation Rth of the second retardation layer was not within the range according to the invention, cause wash out and have a reduced viewing angle contrast.

The present disclosure relates to the subject matter contained in Japanese Patent Application No. 096970/2013, filed on May 2, 2013, and Japanese Patent Application No. 131048/2013, filed on Jun. 21, 2013, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A liquid crystal display device comprising: a first polarizing film; a first retardation layer; a second retardation layer; a liquid crystal layer; a third retardation layer; and a second polarizing film, in sequence, wherein
the liquid crystal layer has four domains or less, and is in a vertical alignment mode (VA mode) under no voltage application,
the first polarizing film has an absorption axis orthogonal to an absorption axis of the second polarizing film,
the first retardation layer has an in-plane retardation Re (550) of 190 to 260 nm at a wavelength of 550 nm, and has a thickness retardation Rth (550) of 80 to 130 nm at a wavelength of 550 nm,
a slow axis of the first retardation layer and the absorption axis of the first polarizing film define an angle of 45°,
the slow axis of the first retardation layer is parallel to an in-plane slow axis of the liquid crystal layer under voltage application,
the absolute value of a retardation Re (550) of the second retardation layer is not larger than 10 nm, while a retardation Rth (550) of the second retardation layer is 150 to 350 nm,
a retardation Re (550) of the third retardation layer is 190 to 260 nm, while a retardation Rth (550) of the third retardation layer is −80 to −130 nm,
a slow axis of the third retardation layer is orthogonal to the slow axis of the first retardation layer, and
a product Δnd of the refractive-index anisotropy Δn and the thickness d (μm) of the liquid crystal layer is 250 to 450 nm.

2. The liquid crystal display device according to claim 1, wherein
the absolute value of a difference in the retardation Re (550) between the first retardation layer and the third retardation layer is not larger than 10 nm, and
a difference in the absolute value of the retardation Rth (550) between the first retardation layer and the third retardation layer is not larger than 10 nm.

3. The liquid crystal display device according to claim 1, wherein at least one of the first retardation layer, the second retardation layer, and the third retardation layer comprises an optically anisotropic layer containing a liquid crystal compound.

4. The liquid crystal display device according to claim 2, wherein at least one of the first retardation layer, the second retardation layer, and the third retardation layer comprises an optically anisotropic layer containing a liquid crystal compound.

5. The liquid crystal display device according to claim 1, further comprising a fourth retardation layer between the first polarizing film and the first retardation layer or between the second polarizing film and the third retardation layer.

6. The liquid crystal display device according to claim 2, further comprising a fourth retardation layer between the first polarizing film and the first retardation layer or between the second polarizing film and the third retardation layer.

7. The liquid crystal display device according to claim 3, further comprising a fourth retardation layer between the first polarizing film and the first retardation layer or between the second polarizing film and the third retardation layer.

8. The liquid crystal display device according to claim 4, further comprising a fourth retardation layer between the first polarizing film and the first retardation layer or between the second polarizing film and the third retardation layer.
